(19) United States
(12) Patent Application Publication
(10) Pub. No.: US 2024/0088356 A1
(43) Pub. Date: Mar. 14, 2024

(54) ELECTRODE ASSEMBLY AND RECHARGEABLE BATTERY INCLUDING THE SAME

(71) Applicant: SAMSUNG SDI CO., LTD., Yongin-si (KR)

(72) Inventors: Junghyun PARK, Yongin-si (KR); Munsung KIM, Yongin-si (KR); Jooyoun SHIN, Yongin-si (KR); Joungku KIM, Yongin-si (KR); Junghyun KIM, Yongin-si (KR); Dongsub LEE, Yongin-si (KR)

(21) Appl. No.: 18/234,813

(22) Filed: Aug. 16, 2023

(30) Foreign Application Priority Data
Sep. 13, 2022 (KR) 10-2022-0115098

(51) Int. Cl. H01M 4/36; H01M 10/04

(52) U.S. Cl. CPC H01M 4/366; H01M 10/0431; H01M 2004/021

(57) ABSTRACT

An electrode assembly includes: a first electrode having a first coated portion and a first uncoated portion at an edge of the first coated portion; a second electrode having a second coated portion and a second uncoated portion at an edge of the second coated portion; a separator between the first electrode and the second electrode; a first insulating layer on one surface of the first uncoated portion; and a second insulating layer on another surface of the first uncoated portion. Lengths of the first insulating layer and the second insulating layer are different from each other.

### CROSS-REFERENCE TO RELATED APPLICATION

This application claims priority to and the benefit of Korean Patent Application No. 10-2022-0115098, filed in the Korean Intellectual Property Office on Sep. 13, 2022, the entire content of which is incorporated herein by reference.

### BACKGROUND

### 1. Field

Embodiments of the present disclosure relate to an electrode assembly and a rechargeable battery including the same.

### 2. Description of the Related Art

Demand for a rechargeable battery as an energy source is increasing as technological development and demand for mobile devices increases. A cylindrical rechargeable battery, from among the various types of rechargeable batteries, may include an electrode assembly formed by disposing two electrodes on opposite surfaces of a separator and winding the disposed electrodes and separator in the form of a jelly roll, a center pin disposed in a hollow portion at a center of the electrode assembly, a case accommodating the electrode assembly, and a cap assembly sealing an open side (or end) of the case.

When the rechargeable battery is charged and discharged, a negative active material layer may swell, deform, or expand, and in this case, a short circuit may occur due to the two electrodes having different polarities contacting each other.

In particular, an uncoated portion (e.g., a first uncoated portion) of one of the two electrodes constituting the electrode assembly may be folded, and the folded first uncoated portion may be electrically connected to a current collector. In this case, an end portion of the other electrode may be disposed to face the folded first uncoated portion. Thus, when the negative active material layer expands, an end portion of a negative electrode may contact a folded uncoated portion of a positive electrode, causing a short circuit to occur.

### SUMMARY

Embodiments of the present disclosure provide an electrode assembly and a rechargeable battery including the electrode assembly capable of preventing a short circuit from occurring when an uncoated portion of a negative electrode contacts an end portion of a positive electrode, even if a negative active material layer expands.

An electrode assembly, according to an embodiment of the present disclosure, includes: a first electrode having a first coated portion and a first uncoated portion at an edge of the first coated portion; a second electrode having a second coated portion and a second uncoated portion at an edge of the second coated portion; a separator between the first electrode and the second electrode; a first insulating layer on one surface of the first uncoated portion; and a second insulating layer on another surface of the first uncoated portion. Lengths of the first insulating layer and the second insulating layer are different from each other.

The first uncoated portion may be bent toward a center of the electrode assembly and may have a portion overlapping and electrically connected to an adjacent first uncoated portion. The other surface of the first uncoated portion may face an end portion of the second electrode and may be spaced apart from the end portion of the second electrode.

The first uncoated portion may have a first region extending from the first coated portion and a second region bent from the first region. The second region may have a portion overlapping the adjacent first uncoated portion. The first insulating layer may be on the first region, and the second insulating layer may be on the second region.

The second insulating layer may be on a part of the second region. The second region may have an exposed surface at where the other surface of the first uncoated portion is exposed, and the exposed surface of the second region may contact one surface of the adjacent first uncoated portion.

The second insulating layer may be on the first region.

The first electrode may be a positive electrode, and the second electrode may be a negative electrode.

A rechargeable battery, according to an embodiment of the present disclosure, includes: an electrode assembly according to any of the above embodiments; a cylindrical case accommodating the electrode assembly; a center pin at a center of the electrode assembly; a cap assembly covering and sealing the cylindrical case; and an electrolyte within the cylindrical case.

### BRIEF DESCRIPTION OF THE DRAWINGS

FIG. 1 is a cross-sectional view of a rechargeable battery according to an embodiment of the present disclosure.

FIG. 2 is a cross-sectional view showing a portion of the electrode assembly shown in FIG. 1.

FIG. 3 is a cross-sectional view showing a portion of the electrode assembly shown in FIG. 1 according to another embodiment.

FIG. 4 is a cross-sectional view of the portion of the electrode assembly shown in FIG. 3 explaining an aspect of the present disclosure.

### DETAILED DESCRIPTION

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

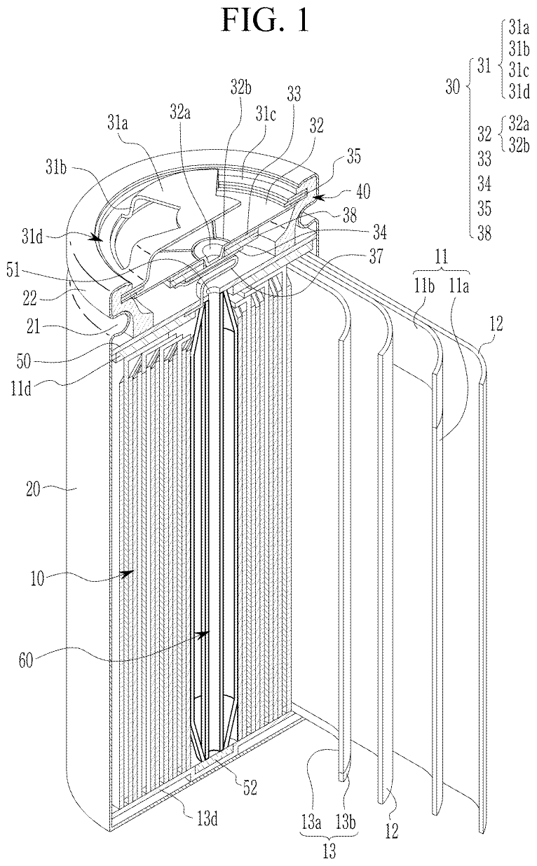

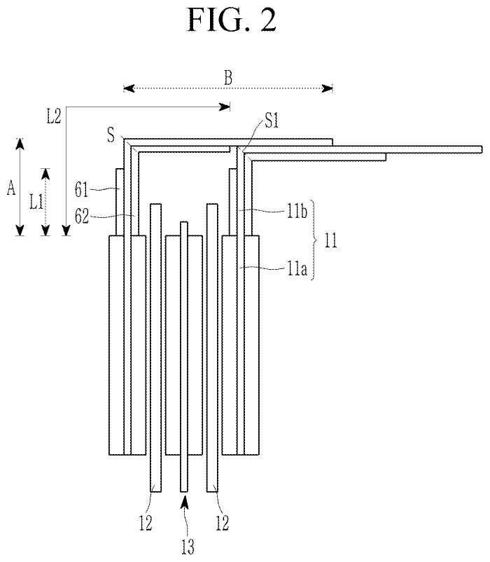

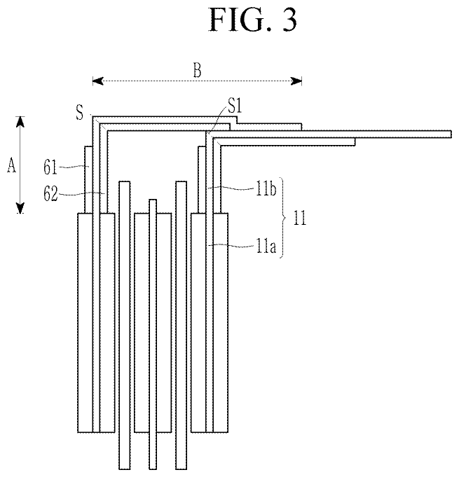

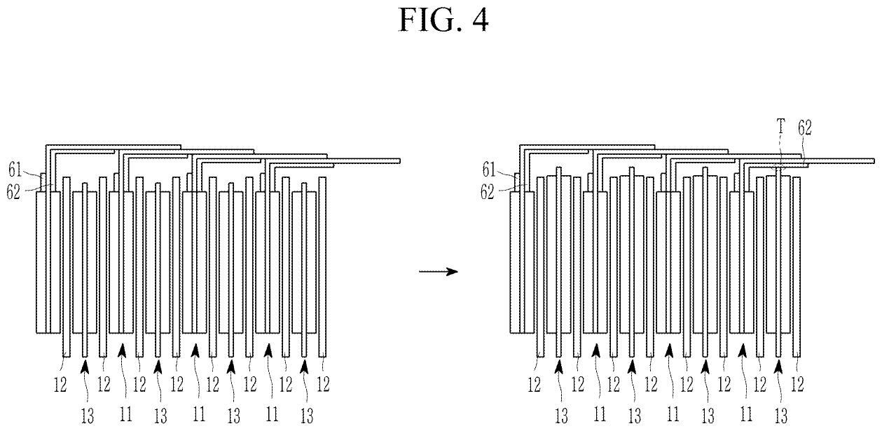

FIG. 1 is a cross-sectional view of a rechargeable battery according to an embodiment of the present disclosure, FIG. 2 is a cross-sectional view showing a portion of the electrode assembly shown in FIG. 1, FIG. 3 is a cross-sectional view showing a portion of the electrode assembly shown in FIG. 1 according to another embodiment, and FIG. 4 is a cross-section view of a portion of the electrode assembly shown in FIG. 2 explaining an aspect of the present disclosure.

As shown in FIG. 1, a rechargeable battery according to an embodiment of the present disclosure includes an electrode assembly 10, a case 20 accommodating the electrode assembly 10, a cap assembly 30 coupled to an opening in the case 20 via a gasket and electrically connected to the electrode assembly 10, an insulating plate 50 between the cap assembly 30 and the electrode assembly 10, and a center pin 60 disposed at a center of the electrode assembly 10.

The electrode assembly 10 includes a first electrode 11, a separator 12, and a second electrode 13 that are sequentially stacked. The electrode assembly 10 may be a cylindrical jelly roll in which the first electrode 11, the separator 12, and the second electrode 13 are stacked and then wound together around the center pin 60.

The separator 12 may be disposed between the first electrode 11 and the second electrode 13 and may insulate the first electrode 11 and the second electrode 13 from each other. The separator 12 may include (or may be formed of) polyethylene, polypropylene, polyvinylidene fluoride or may be a multilayer film including two or more layers thereof. In such an embodiment, the separator 12 may be a mixed multilayer film, such as a polyethylene/polypropylene two-layer separator, a polyethylene/polypropylene/polyethylene three-layer separator, a polypropylene/polyethylene/polypropylene three-layer separator, or the like.

The first electrode 11 may have a first coated portion 11a and a first uncoated portion 11b, and the second electrode 13 may have a second coated portion 13a and a second uncoated portion 13b. Each of the first coated portion 11a and the second coated portion 13a is a region at where an active material layer is disposed on both sides of a current collector composed of a thin metal plate. Each of the first uncoated portion 11b and the second uncoated portion 13b is a region at where the surface of the current collector is exposed because an active material layer is not disposed thereof. The first uncoated portion 11b and the second uncoated portion 13b may be positioned at opposite ends of the electrode assembly 10 with respect to each other (e.g., the first uncoated portion 11b may be a top of the electrode assembly 10, and the second uncoated portion 13b may be at a bottom of the electrode assembly 10). In one embodiment, the first electrode 11 may be a positive electrode, and the second electrode 13 may be a negative electrode.

The electrode assembly 10 may be rolled in a jelly roll shape. A first electrode current collector 11d may be positioned on one side (e.g., an upper side with reference to FIG. 1) of the electrode assembly 10, and a second electrode current collector 13d may be positioned on the other side (e.g., a lower side with reference to FIG. 1) of the electrode assembly 10. The first electrode current collector 11d may be connected to the first uncoated portion 11b of the electrode assembly 10, and a second electrode current collector 13d may be connected to the second uncoated portion 13b of the electrode assembly 10.

The second electrode current collector 13d contacts (e.g., directly contacts) the case 20, while the first electrode current collector 11d does not contact (e.g., does not directly contact) the case 20. For example, the first electrode current collector 11d may have a smaller width than the second electrode current collector 13d.

Referring to FIGS. 1 and 2, the first uncoated portion 11b of the first electrode 11 may be bent toward the center pin 60 that is at a center of the electrode assembly 10, and adjacent first uncoated portions 11b may be stacked to overlap (e.g., to at least partially overlap) each other to be electrically connected to each other. The first uncoated portion 11b may be electrically connected to the first electrode current collector 11d in an overlapping state.

The first uncoated portion 11b has one surface (e.g., an upper surface with reference to FIG. 2) contacting and electrically connected to the first electrode current collector 11d and another (e.g., an opposite) surface (e.g., a lower surface with reference to FIG. 2) facing an end portion of the second electrode 13 (e.g., an end portion of the second coated portion 13a of the second electrode 13). The other surface of the first uncoated portion 11b is spaced apart from the end portion of the second electrode 13.

A first insulating layer 61 is positioned on the one surface of the first uncoated portion 11b, and a second insulating layer 62 is positioned on the other surface of the first uncoated portion 11b. The length L1 of the first insulating layer 61 (e.g., the length of the first insulating layer 61 from the end of the first coated portion 11a) and the length L2 of the second insulating layer 62 (e.g., the length of the second insulating layer 62 from the end of the first coated portion 11a) are different from each other. A direction from one end of the first uncoated portion 11b contacting (or extending from) the first coated portion 11a to the opposite end of the first uncoated portion 11b may be referred to as a longitudinal direction of the first uncoated portion 11b. The lengths L1 and L2 of the first and second insulating layers 61 and 62 may refer to lengths measured along the longitudinal direction of the first uncoated portion 11b.

The first uncoated portion 11b has a first region A extending from the first coated portion 11a and a second region B extending from the first region A. The first region A may be parallel to the first coated portion 11a, and the second region B may be bent from the first region A at a bending area (e.g., a bending line S) to cross (e.g., to extend at an angle from or perpendicular to) the first region A. The second region B may have a portion overlapping with the adjacent first uncoated portion 11b (e.g., at least partially overlapping with the second region B of the adjacent first uncoated portion 11b).

The first insulating layer 61 may be disposed on the first region A, and the second insulating layer 62 may be disposed on the first region A and on a part of the second region B. An end of the first insulating layer 61 may be at the bending line S at where the first uncoated portion 11b is bent or may be disposed below the bending line S.

The second insulating layer 62 may be disposed on a part of the second region B. For example, the second region B may have an exposed surface at where the second insulating layer 62 is not disposed thereon for contact with the exposed surface of the adjacent first uncoated portion 11b. For example, the second insulating layer 62 may be positioned from the bending line S of the first uncoated portion 11b to the bending line S1 of the adjacent first uncoated portion 11b. The first uncoated portion 11b may overlap the adjacent first uncoated portion 11b at the exposed surface to be electrically connected to the adjacent first uncoated portion 11b.

In addition, the second insulating layer 62 may be positioned to extend to the first region A to prevent a short circuit with the second uncoated portion 13b. In FIG. 2, an embodiment in which the second insulating layer 62 is positioned over the entire first region A and a part of the second region B is shown.

In FIG. 2, it is shown that the second insulating layer 62 is positioned from (e.g., extends from) the end of the first uncoated portion 11b from the first coated portion 11a to the bending line S1 of the adjacent first uncoated portion 11b, but the present disclosure is not limited thereto. As illustrated in FIG. 3, in another embodiment, an end of the second insulating layer 62 may be disposed to exceed (e.g., to extend over and/or beyond) the bending line S1 of the adjacent first uncoated portion 11b.

The first uncoated portion 11b is easily bent due to its thin thickness. Because the thickness of the second insulating layer 62 is small, the first uncoated portion 11b may be easily bent along the end of the second insulating layer 62 to cover the end of the second insulating layer 62. Therefore, even if the second insulating layer 62 is disposed between the first uncoated portion 11b and the adjacent first uncoated portion 11b, the first uncoated portion 11b may be easily contacted by and electrically connected to the adjacent first uncoated portion 11b.

Referring to FIG. 4, because the first insulating layer 61 and the second insulating layer 62 are disposed as shown in the above-described embodiments of the present disclosure, an end (e.g., an upper end) of the second electrode 13 contacts the second insulating layer 62 so that a short circuit does not occur even if the end (e.g., the upper end) of the second electrode 13 protrudes due to expansion of the active material layer on the second electrode 13 during charging and discharging. In FIG. 4, the contact point between the upper end of the second electrode 13 and the second insulating layer 62 is indicated by T.

Referring again to FIG. 1, a lead tab 37 is electrically connected to the first electrode current collector 11d.

One end of the lead tab 37 may be connected to the first electrode current collector 11d by welding, and the other end of the lead tab 37 may be electrically connected to the cap assembly 30. The lead tab 37 may be bent so that one surface of the lead tab 37 faces the electrode assembly 10 to increase its contact area with the cap assembly 30.

The insulating plate 50 has an opening 51 exposing the center pin 60 and is disposed on the first electrode current collector 11d.

The insulating plate 50 may be larger than the first electrode current collector 11d so that the insulating plate 50 contacts an inner surface of the case 20. When the insulating plate 50 is provided to be larger than the first electrode current collector 11d, a gap (e.g., a predetermined gap) exists between the first electrode current collector 11d and the case 20 due to a width of the insulating plate 50 protruding beyond the first electrode current collector 11d. This gap between the first electrode current collector 11d and the case 20 may prevent a short circuit due to contact between the first electrode current collector 11d and the case 20.

The lead tab 37 may contact a first auxiliary plate 34 of the cap assembly 30, to be described later, to be electrically connected to the first auxiliary plate 34 through the opening 51 in the insulating plate 50.

Because the electrode assembly 10 is wound around the center pin 60, the center pin 60 may be disposed at a center of the electrode assembly 10 and may be disposed parallel to a direction in which the electrode assembly 10 is inserted into the case 20.

The center pin 60 may be minimally deformed or may maintain a shape close to a pre-deformation shape even when the center pin 60 receives a front compressive load or a local impact load acting on the outside of the rechargeable battery.

The center pin 60 may be made of a material (e.g., a conductive metal) having a certain rigidity such that it is minimally deformed against an external impact. Because the center pin 60 is conductive, both ends of the center pin 60 may be installed to be electrically insulated from the first electrode current collector 11d and the second electrode current collector 13d.

That is, an insulating pad 52 may be disposed between a lower end of the center pin 60 and the second electrode current collector 13d, while an upper end of the center pin 60 passes through a through hole (e.g., an opening) disposed at a center of the first electrode current collector 11d in an insulated state to be supported by the insulating plate 50. In such an embodiment, the upper end of the center pin 60 may be spaced apart from the through hole in the first electrode current collector 11d or an insulating member may be interposed between the upper end of the center pin 60 and the through hole in the first electrode current collector 11d. Therefore, movement of the center pin 60 may be restricted in a longitudinal direction of the center pin 60, and the center pin 60 may maintain a stable state at a center of the electrode assembly 10.

One side (e.g., an upper side) of the case 20 may be open so that the electrode assembly 10 can be inserted into the case 20 together with an electrolyte. The case 20 may be made to have approximately the same shape as a jelly roll-shaped electrode assembly 10, and for example, the case 20 may have a cylindrical shape.

The case 20 may be connected to the second electrode current collector 13d to act as a second electrode terminal of the rechargeable battery. Accordingly, the case 20 may be made of a conductive metal, such as aluminum, aluminum alloy, or nickel-plated steel. The electrode assembly 10 may be inserted into the case 20 together with the electrolyte and may then be sealed.

The electrolyte may include a lithium salt and an organic solvent. The lithium salt may include LiPF₆, LiBF₄, and the like. The organic solvent may include ethylene carbonate (EC), propylene carbonate (PC), diethyl carbonate (DEC), ethyl methyl carbonate (EMC), and the like. The electrolyte may be in a liquid, solid, or gel state.

The cap assembly 30 is disposed at the opening in the case 20 and is coupled to the case 20 with the gasket 40 interposed between the cap assembly 30 and the case 20. The gasket 40 insulates the case 20 and the cap assembly 30 and seals the inside of the case 20 accommodating the electrode assembly 10 and the electrolyte.

The cap assembly 30 may include a cap plate 31, a positive temperature coefficient (PTC) element 35, a vent plate 32, an insulating member 33, the first auxiliary plate 34, and a second auxiliary plate 38.

The first auxiliary plate 34 may be electrically connected to the lead tab 37 and may be coupled to the lead tab 37 by welding. The second auxiliary plate 38 may be stacked on the first auxiliary plate 34 to be electrically connected to the first auxiliary plate 34 and may be coupled to the first auxiliary plate 34 by welding. The second auxiliary plate 38 is disposed at a center of the cap assembly 30 corresponding to the center pin 60 and has a through hole exposing the first auxiliary plate 34.

The vent plate 32 is disposed above the second auxiliary plate 38 with the insulating member 33 interposed between the vent plate 32 and the second auxiliary plate 38. An edge of the vent plate 32 may be inserted into the gasket 40 to be coupled to the case 20.

The vent plate 32 may include a vent 32a disposed at a portion corresponding to the center pin 60. The vent 32a protrudes from the vent plate 32 toward the electrode assembly 10 and contacts the first auxiliary plate 34 through the through hole in the second auxiliary plate 38 to be electrically connected to the first auxiliary plate 34. The vent plate 32 may have a notch 32b around the vent 32a that guides breakage of the vent 32a (e.g., that controls breakage or bursting of the vent 32a at a reference pressure).

The vent 32a may be broken in response to a pressure condition (e.g., a reference or predetermined pressure condition) to release internal gas to the outside and block electrical connection with the first auxiliary plate 34. For example, when an internal pressure in the case 20 rises due to generation of gas, the notch 32b may burst so that the gas is discharged to the outside through an exhaust port 31d, to be described later. Thus, explosion of the rechargeable battery may be prevented.

In addition, if an abnormal reaction continues, damaging the vent 32a, an electrical connection between the vent plate 32 and the first auxiliary plate 34 is disconnected. Accordingly, an electrical connection between the cap plate 31 electrically connected to the vent plate 32 and the first auxiliary plate 34 is disconnected so that no more current flows.

The cap plate 31 may include a center plate 31a corresponding to the center pin 60 that is at a center of the electrode assembly 10, a plurality of branch portions 31b extending from the center plate 31a toward the gasket 40, and a coupling plate 31c connecting ends of the branch portions 31b and inserted into the gasket 40 to be coupled to the gasket 40. A space between adjacent branch portions 31b is opened to the outside to form the exhaust port 31d for emitting internal gas.

The branch portion 31b may be bent from the coupling plate 31c to be connected to the center plate 31a so that a center of the cap plate 31 protrudes outside (e.g., protrudes above) the case 20. The cap plate 31 may be electrically connected to the first electrode current collector 11d through the vent plate 32, the second auxiliary plate 38, the first auxiliary plate 34, and the lead tab 37 so that the cap plate 31 acts as a first electrode terminal of the rechargeable battery. Therefore, when a center of the cap plate 31 protrudes outside of (e.g., protrudes above) the case 20, a terminal connection with an external device may be easily facilitated.

The PTC element 35 may be disposed along coupling plate 31c of the cap plate 31 and may be inserted into the gasket 40 in a stacked state between the coupling plate 31c and an edge of the vent plate 32 to be coupled to the gasket 40.

The PTC element 35 may be installed between the cap plate 31 and the vent plate 32 to regulate current flow between the cap plate 31 and the vent plate 32 according to an internal temperature of the rechargeable battery.

When the internal temperature is within a reference (or predetermined) range, the positive temperature coefficient element 35 acts as a conductor to electrically connect the cap plate 31 and the vent plate 32. However, when the internal temperature exceeds the reference (or predetermined) temperature, an electrical resistance of the positive temperature coefficient element 35 increases to infinity. Accordingly, in this case, the positive temperature coefficient element 35 may block flow of a charging or discharging current between the cap plate 31 and the vent plate 32.

After the electrode assembly 10 is inserted into the case 20, the vent plate 32, the PTC element 35, and the cap plate 31 are inserted into the gasket 40 in a stacked state at an edge of the cap assembly 30, and then, the cap assembly 30 is inserted into the opening in the case 20.

In addition, the cap assembly 30 is fixed at the opening in the case 20 through a crimping process. In such an embodiment, a beading portion (e.g., a bead) 21 and a crimping portion (e.g., a crimp) 22 may be provided adjacent to the opening in the case 20. The beading portion 21 may be provided through (or formed through) a beading process. The beading portion 21 has a structure in which the beading portion 21 is recessed toward a center of case 20 in a radial direction thereof at an upper side of the case 20 when the electrode assembly 10 is accommodated in the case 20, and the beading portion 21 prevents the electrode assembly 10 from moving up and down.

The crimping portion 22 has a structure that relatively protrudes from the beading portion 21 in a radial direction and is connected to the beading portion 21 so that the crimping portion 22 holds an outer circumferential surface of the cap assembly and upper and lower surfaces connected to the outer circumferential surface with the gasket 40.

While this disclosure has been described in connection with what is presently considered to be practical embodiments, it is to be understood that the disclosure is not limited to the disclosed embodiments. On the contrary, the present disclosure is intended to cover various modifications and equivalent arrangements included within the spirit and scope of the appended claims and their equivalents.

What is claimed is:

1. An electrode assembly comprising:
a first electrode having a first coated portion and a first uncoated portion at an edge of the first coated portion;
a second electrode having a second coated portion and a second uncoated portion at an edge of the second coated portion;
a separator between the first electrode and the second electrode;
a first insulating layer on one surface of the first uncoated portion; and
a second insulating layer on another surface of the first uncoated portion,
wherein lengths of the first insulating layer and the second insulating layer are different from each other.

2. The electrode assembly of claim 1, wherein the first uncoated portion is bent toward a center of the electrode assembly and has a portion overlapping and electrically connected to an adjacent first uncoated portion, and
wherein the other surface of the first uncoated portion faces an end portion of the second electrode and is spaced apart from the end portion of the second electrode.

3. The electrode assembly of claim 2, wherein the first uncoated portion has a first region extending from the first coated portion and a second region bent from the first region,
wherein the second region has a portion overlapping the adjacent first uncoated portion,
wherein the first insulating layer is on the first region, and
wherein the second insulating layer is on the second region.

4. The electrode assembly of claim 3, wherein the second insulating layer is on a part of the second region,
wherein the second region has an exposed surface at where the other surface of the first uncoated portion is exposed, and
wherein the exposed surface of the second region contacts one surface of the adjacent first uncoated portion.

5. The electrode assembly of claim 3, wherein the second insulating layer is on the first region.

6. The electrode assembly of claim 1, wherein the first electrode is a positive electrode, and the second electrode is a negative electrode.

7. A rechargeable battery comprising:
an electrode assembly comprising:
a first electrode having a first coated portion and a first uncoated portion at an edge of the first coated portion;
a second electrode having a second coated portion and a second uncoated portion at an edge of the second coated portion;
a separator between the first electrode and the second electrode,
a first insulating layer on one surface of the first uncoated portion; and
a second insulating layer on another surface of the first uncoated portion, lengths of the first insulating layer and the second insulating layer being different from each other;
a cylindrical case accommodating the electrode assembly;
a center pin at a center of the electrode assembly;
a cap assembly covering and sealing the cylindrical case; and
an electrolyte within the cylindrical case.

8. The rechargeable battery of claim 7, wherein the first uncoated portion is bent toward a center of the electrode assembly and has a portion overlapping and electrically connected to an adjacent first uncoated portion, and
wherein the other surface of the first uncoated portion faces an end portion of the second electrode and is spaced apart from the end portion of the second electrode.

9. The rechargeable battery of claim 8, wherein the first uncoated portion has a first region extending from the first coated portion and a second region bent from the first region,
wherein the second region has a portion overlapping the adjacent first uncoated portion,
wherein the first insulating layer is on the first region, and
wherein the second insulating layer is on the second region.

10. The rechargeable battery of claim 9, wherein the second insulating layer is on a part of the second region,
wherein the second region has an exposed surface at where the other surface of the first uncoated portion is exposed, and
the exposed surface of the second region contacts one surface of the adjacent first uncoated portion.

11. The rechargeable battery of claim 9, wherein the second insulating layer on the first region.

12. The rechargeable battery of claim 7, wherein the first electrode is a positive electrode, and the second electrode is a negative electrode.
